(19) United States
(12) Patent Application Publication
(10) Pub. No.: US 2025/0148151 A1
(43) Pub. Date: May 8, 2025

(54) METHOD AND SYSTEM TO MANAGE DESIGN INFORMATION OF MOTORIZED PARTS FOR VEHICLES

(71) Applicants: HYUNDAI MOTOR COMPANY, Seoul (KR); KIA CORPORATION, Seoul (KR)

(72) Inventor: Se Hoon Park, Hwaseong-si (KR)

(73) Assignees: HYUNDAI MOTOR COMPANY, Seoul (KR); KIA CORPORATION, Seoul (KR)

(21) Appl. No.: 18/938,956

(22) Filed: Nov. 6, 2024

(30) Foreign Application Priority Data
Nov. 7, 2023 (KR) 10-2023-0152848

(51) Int. Cl. G06F 30/15; G06F 30/20; G06F 119/02

(52) U.S. Cl. CPC G06F 30/15; G06F 30/20; G06F 2119/02

(57) ABSTRACT

A method of managing information on design of electric components for vehicles may include: defining a standard version management system and a standard code management system for at least one electric component as a document classification format and defining a document processing status and a document processing process to respond to requests from an external source based on the document classification format; registering the component as a standard component and managing information on the version of the standard component and the functions related thereto; registering at least one standard component applied to at least one vehicle model and managing the functions of the standard component and the functions related thereto; receiving information related the standard component applied to the vehicle model and reviewing reliability of the information; and receiving design information of the information related the standard component applied to the vehicle model and updating and notifying changed information.

### CROSS-REFERENCE TO RELATED APPLICATIONS

The present application claims the benefit of and priority to Korean Patent Application No. 10-2023-0152848, filed on Nov. 7, 2023, the entire contents of which are hereby incorporated herein by reference.

### TECHNICAL FIELD

The present disclosure relates to a method and system for managing information on the design of motorized parts for vehicles.

### BACKGROUND

The statements in this section merely provide background information related to the present disclosure and may not constitute prior art.

In the trend of vehicle electrification and advancement, existing mechanical parts have been replaced by motorized parts. For example, the mechanical transmission gear shift (TGS) lever has been replaced by an electronic shift by wire (SBW). As another example, the mechanical clutch pedal has been replaced by an electronic E-clutch system.

In addition, internal combustion engines have been replaced by electric motors. Further, as autonomous driving and connectivity functions have been incorporated in line with the trends of the times, the number and complexity of electronic systems such as controllers and sensors in vehicles have been continuously increasing.

Furthermore, vehicles are no longer classified as mechanical devices. Vehicles are now recognized as electronic products based on software under the concept of software defined vehicles (SDV), and there have been changes in related technologies accordingly.

Such an increase in the number of electronic systems naturally leads to an increase in the type and number of controllers. The number of controllers that can be applied to vehicles currently exceeds 200.

The conventional method of designing controllers by linking the above-mentioned controllers with each other is as shown in FIG. 1. Because the purposes of the controllers are all different, the control methods and control functions are all different, and related information required for controller design also varies depending on the controller. Ultimately, as there are more types of controllers, the controller design process becomes more complex. As a result, errors in design information cause frequent controller malfunctions, increasing vehicle development time/cost and lowering design quality.

In addition, as vehicles become increasingly electronic, more types of controllers are needed. In order to design all the controllers, the design information required for the design of each controller needs to be received from various related teams at various times.

For this reason, the procedures and rules for receiving design information vary depending on controller, and design information that has not been computerized or converted into data is received and managed on each individual designer's personal computer (PC) through unofficial channels. As a result, such design information cannot be reused, and significant loss such as design omissions and errors in the information exchange process is caused.

Although a computerized system has been established to receive design information for some controllers, it is a non-general and non-extensible system that is designed only for specific controllers and cannot be applied to all controllers in vehicles.

Therefore, the quality of the design of vehicle controllers deteriorates, and the time and cost required to develop the vehicle controllers are increased.

The information included in this Background of the present disclosure section is intended merely to enhance understanding of the general background of the present disclosure. Therefore, the Background section should not be taken as an acknowledgement or any form of suggestion that this information forms the prior art already known to a person of ordinary skill in the art to which the present disclosure pertains.

### SUMMARY

Embodiments of the present disclosure are aimed at resolving the above-described problems.

A method and system for managing information on the design of electric components for vehicles according to embodiments of the present disclosure provide a general-purpose and extendible system for managing information on the design of controllers, where concepts such as a document processing process, a document processing status, a controller standard code management system, a controller standard version management system, a controller design information standard management, a controller design information project management, a controller design information processing management, and a controller design information status management are defined in order to establish a system for designing controllers based on a platform rather than conducting a separate design process for each controller or vehicle model, and the functions corresponding thereto are performed to manage computerized and standardized design information that can be reused for controllers with various purposes and characteristics.

According to an embodiment, a method of managing information on the design of electric components for vehicles is provided. The method includes a standardization step of defining a standard version management system and a standard code management system for at least one electric component for vehicles in a document classification format and defining a document processing status and a document processing process to respond to requests from an external source based on the document classification format. The method also includes a design information standard management step of registering the at least one electric component as a standard component based on the standardization step and managing information on a version and a related function of the standard component. The method further includes a design information project management step of registering at least one standard component applied to at least one vehicle model and managing a function of the standard component and functions related thereto. The method additionally includes a design information processing management step of receiving information related the standard component applied to the vehicle model and then reviewing reliability of the information related thereto. The method further includes a design information status management step of receiving design information of the information related the standard component applied to the vehicle model and then updating and notifying changed information.

According to an embodiment of the present disclosure, the standardization step may include a standard version management system definition step of coding respective versions related to the electric component into a first database and then updating information on a version of the electric component based on the first database, a standard code management system definition step of indexing the electric component, coding it into a second database based on the index, and then updating information on a code of the electric component based on the second database, a document processing state definition step of linking the first database and the second database and defining a document state based on the document classification format, and a document processing process definition step of defining a document processing process to respond to an inquiry regarding design information from an external source based on the document state defined in the document processing state definition step.

According to an embodiment of the present disclosure, based on the standardization step, the design information standard management step may include a standard component registration management step of updating information on the component, a standard component manager management step of updating information on a person in charge of the standard component, a standard component version management step of updating a version of the standard component, and a standard component related functions management step of updating information on functions related to the standard component.

According to an embodiment of the present disclosure, the standard component registration management step may include selecting a major classification for the standard component by selecting a 2-digit standard code and then registering a name, a 4-digit standard code, and the version of the standard component.

According to an embodiment of the present disclosure, in the standard component manager management step, when an inquiry regarding the standard component is received, a designated person in charge may be informed of receipt of the inquiry through a computerized system, and it may be possible to update information on the person in charge.

According to an embodiment of the present disclosure, in the standard component version management step, an initial version of the standard component is registered as version X.xx (x is an integer determined from 1 to 9), additional versions are registered by increasing the second decimal place of the version X.xx by 1, a latest version of the standard component is set as a current version, and it is checked whether the current version overlaps with existing versions.

According to an embodiment of the present disclosure, in the standard component-related functions management step, a name of a function of the standard component and a 6-digit standard code are registered, names of functions that can be related to the standard component and an 8-digit standard code are registered, and information on inquiries/responses/options regarding the functions related to the standard component is registered in a viewable form.

According to an embodiment of the present disclosure, based on the standardization step, the design information project management step may include a step of registering and linking vehicle models and their components, in which the vehicle models and at least one standard component applied to each of the vehicle models are registered and linked to each other, a step of managing functions of each component, in which information on the functions of the standard component linked in the step of registering and linking vehicle models and their components and the functions related to the component is updated and managed, and a step of managing functions related to each vehicle model, in which information on inquiries/responses regarding the functions related to the component, which are updated and managed in the step of managing functions of each component, is managed.

According to an embodiment of the present disclosure, in the step of managing functions of each component, the functions of the component and the functions related thereto may be modified to fit the vehicle model, and the modified information and the added information may be managed as additional items.

According to an embodiment of the present disclosure, based on the standardization step, the design information status management step may include a step of retrieving information on components of each vehicle model, in which design information is retrieved based on the information on components of each vehicle model and a request for design information varying as details progress is made, a step of managing how information on components of each vehicle model is received, in which how the related functions have been received by each team is managed for matters requested in the step of retrieving information on components of each vehicle model, and a step of providing an alarm regarding information on components of each vehicle model, in which an alarm regarding a request for additional information on the related functions is provided to a person in charge when there is such a request among the requests managed in the step of managing how information on components of each vehicle model is received.

According to another embodiment of the present disclosure, a system for managing information on the design of electric components for vehicles is provided. The system includes a computer communication interface module for updating and retrieving information and transmitting and receiving inquiries and responses. The system also includes a standardization module for defining a standard version management system and a standard code management system for at least one electric component for vehicles in a document classification format and defining a document processing status and a document processing process to respond to requests received through the computer communication interface module based on the document classification format. The system further includes a design information standard management module for registering the at least one electric component as a standard component through the computer communication interface module based on the standardization module and managing information on a version and a related function of the standard component. The system additionally includes a design information project management module for registering at least one standard component applied to at least one vehicle model through the computer communication interface module based on the standardization module and managing a function of the standard component and functions related thereto. The system further includes a design information processing management module for receiving information related the standard component applied to the vehicle model through the computer communication interface module based on the standardization module and then reviewing reliability of the information related thereto. The system further still includes a design information status management module for receiving the design information of the information related the standard component applied to the vehicle model through the computer communication interface module based on the standardization module and then updating and notifying changed information.

According to an embodiment of the present disclosure, the standardization module may include a standard version management system definition module for coding respective versions related to the electric component into a first database and then updating information on a version of the electric component based on the first database, a standard code management system definition module for indexing the electric component, coding it into a second database based on the index, and then updating information on a code of the electric component based on the second database, a document processing state definition module for linking the first database and the second database and defining a document state based on the document classification format, and a document processing process definition module for defining a document processing process to respond to an inquiry regarding design information from an external source based on the document state defined through the document processing state definition module.

According to an embodiment of the present disclosure, based on the standardization module, the design information standard management module may include a standard component registration management module for updating information on the component, a standard component manager management module for updating information on a person in charge of the standard component, a standard component version management module for updating a version of the standard component, and a standard component related functions management module for updating information on functions related to the standard component.

According to an embodiment of the present disclosure, the standard component registration management module may select a major classification for the standard component by selecting a 2-digit standard code and then registers a name, a 4-digit standard code, and the version of the standard component.

According to an embodiment of the present disclosure, the standard component manager management module may inform a designated person in charge of receipt of an inquiry regarding the standard component through a computerized system when the inquiry has been received, and it may be possible to update information on the person in charge.

According to an embodiment of the present disclosure, the standard component version management module may register the initial version of the standard component as version X.xx (x is an integer determined from 1 to 9), additional versions are registered by increasing the second decimal place of the version X.xx by 1, sets a latest version of the standard component as a current version, and checks whether the current version overlaps with existing versions.

According to an embodiment of the present disclosure, the standard component-related functions management module may register a name of a function of the standard component and a 6-digit standard code, registers names of functions that can be related to the standard component and an 8-digit standard code, and then registers information on inquiries/responses/options regarding the functions related to the standard component in a viewable form.

According to an embodiment of the present disclosure, based on the standardization module, the design information project management module may include a management module for registering and linking vehicle models and their components, which is for registering and linking each of the vehicle models and at least one standard component applied to each of the vehicle models, a module for managing functions of each component, which is for updating and managing information on the functions of the standard component linked through the management module for registering and linking vehicle models and their components and the functions related to the component, and a module for managing functions related to each vehicle model, which is for managing information on inquiries/responses regarding the functions related to the component, which are updated and managed through the module for managing functions of each component.

According to an embodiment of the present disclosure, the module for managing functions of each component may modify the functions of the component and the functions related thereto to fit the vehicle model, and may manage the modified information and the added information as additional items.

According to an embodiment of the present disclosure, based on the standardization module, the design information status management module may include a module for retrieving information on components of each vehicle model, which is for retrieving design information based on the information on components of each vehicle model and making a request for design information varying as details progress, a module for managing how information on components of each vehicle model is received, which is for managing how the related functions have been received by each team for matters requested through the module for retrieving information on components of each vehicle model, and a module for providing an alarm regarding information on components of each vehicle model, which is for providing an alarm regarding a request for additional information on the related functions to a person in charge when there is such a request among the requests managed through the module for managing how information on components of each vehicle model is received.

Design information with different characteristics for each controller has been managed in a non-standardized and non-computerized manner for each controller, vehicle model, and person in charge. As a result, design information may be missing, it is not possible to reuse design information, the complexity of design information increases, and design quality deteriorates, leading to massive loss of the entire vehicle, such as deterioration in quality, increase in development period, and increase in cost. In this regard, embodiments of the present disclosure provide a method and system for managing information on the design of electric components for vehicles in order to efficiently manage information on the design of vehicle controllers, of which the number of types is rapidly increasing due to the electronics and advancement of vehicles, and secure versatility/extendibility/standardization of the design information while improving the competitiveness of vehicles by enhancing the quality of controller design.

The methods and apparatuses according to embodiments of the present disclosure have other features and advantages that should be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a conceptual view for an overview of the conventional design process.

FIG. 2 a conceptual view for an overview of the design process to which the system for managing design information according to an embodiment of the present disclosure may be applied.

FIG. 3 is a block diagram for showing the components of the system for managing design information according to an embodiment of the present disclosure.

FIGS. 4-7 show the components of each component in FIG. 3, according to embodiments of the present disclosure.

It should be understood that the appended drawings are not necessarily to scale, presenting a somewhat simplified representation of various features illustrative of the basic principles of the present disclosure. The specific design features of embodiments of the present disclosure as included herein, including, for example, specific dimensions, orientations, locations, and shapes, will be determined in part by the particularly intended application and use environment.

In the figures, the same reference numerals refer to the same or equivalent parts of the present disclosure throughout the several figures of the drawing.

### DETAILED DESCRIPTION

Because various changes can be made to the present disclosure and a range of embodiments can be made for the present disclosure, specific embodiments are illustrated in the drawings and described in more detail below. However, this is not intended to limit the present disclosure to the specific embodiments, and it should be understood that the present disclosure includes all changes, equivalents, and substitutes within the technology and the scope of the present disclosure.

The terms “module” and “unit” used in the present disclosure are merely used to distinguish the names of components, and should not be interpreted as assuming that the components have been physically or chemically separated or can be so separated.

Terms containing ordinal numbers such as “first” and “second” may be used to describe various components, but the components are not limited by the terms. The above-mentioned terms are used merely as names to distinguish one component from another component, and the order therebetween may be determined by the context in the descriptions thereof, not by such names.

The expression “and/or” is used to include all possible combinations of multiple items being addressed. For example, by “A and/or B,” all three possible combinations are meant: “A,” “B,” and “A and B.”

When a component is said to be “coupled” or “connected” to another component, it means that the component may be directly coupled or connected to the other component or there may be other components therebetween.

When a component, device, module, element, or the like of the present disclosure is described as having a purpose or performing an operation, function, or the like, the component, device, or element should be considered herein as being “configured to” meet that purpose or perform that operation or function.

The terms used herein are only used to describe specific embodiments and are not intended to limit the present disclosure. Expressions in the singular form include the meaning of the plural form unless they clearly mean otherwise in the context. In the present disclosure, expressions such as “comprise,” “include,” or “have” are intended to indicate the presence of features, numbers, steps, operations, components, parts, or combinations thereof described herein. Such expressions should not be understood as precluding the possibility of the presence or the addition of one or more other features, numbers, steps, operations, components, parts, or combinations thereof.

Unless otherwise defined, all terms used herein, including technical or scientific terms, have meanings commonly understood by a person having ordinary skill in the technical field to which the present disclosure pertains. Terms defined in commonly used dictionaries should be interpreted as having meanings consistent with the meanings they have in the context of the relevant technology, and should not be interpreted in an ideal or overly formal sense unless explicitly defined in the present disclosure.

In addition, a module, a unit, a control unit, a control device, or a controller is only a term widely used to name devices for controlling a certain function, and do not mean a generic function unit. For example, devices with these names may include a communication device that communicates with other controllers or sensors to control a certain function, a computer-readable recording medium that stores an operating system, logic instructions, input/output information, etc., and one or more processors that perform operations of determination, calculation, making decisions, etc. required to control the function.

The processor may include a semiconductor integrated circuit and/or electronic devices that carry out operations of at least one of comparison, determination, calculation, and making decisions to perform a programmed function. For example, the processor may be any one or a combination of a computer, a microprocessor, a CPU, an ASIC, and an electronic circuit such as circuitry and logic circuits.

Examples of a computer-readable recording medium (or simply called a memory) may include all types of storage devices for storing data that can be read by a computer system. For example, examples of a computer-readable recording medium may include at least one of a memory such as a flash memory, a hard disk, a micro memory, and a card memory, e.g., a secure digital card (SD card) or an eXtream digital card (XD card), and a memory such as a random access memory (RAM), a static ram (SRAM), a read-only memory (ROM), a programmable ROM (PROM), an electrically erasable PROM (EEPROM), a magnetic RAM (MRAM), a magnetic disk, and an optical disk.

Such a recording medium may be electrically connected to the processor, and the processor may load and write data from the recording medium. The recording medium and the processor may be integrated or may be physically separate devices.

Hereinafter, with reference to the accompanying drawings, a method and system for managing information on the design of electric components for vehicles according to embodiments of the present disclosure are described.

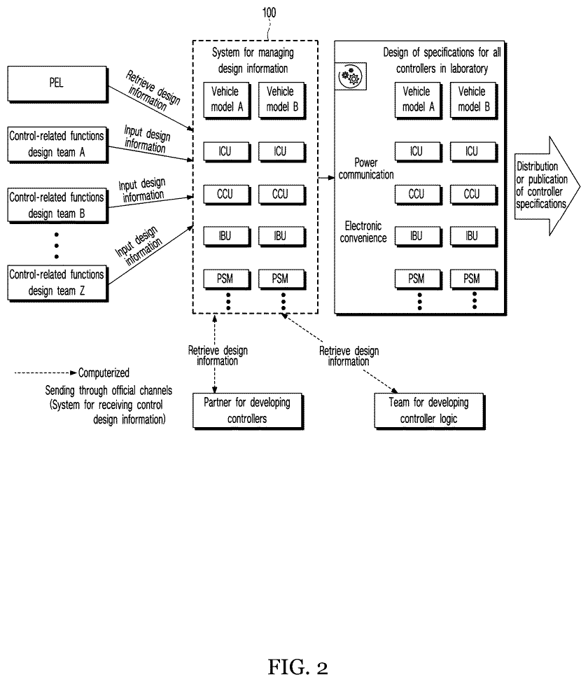

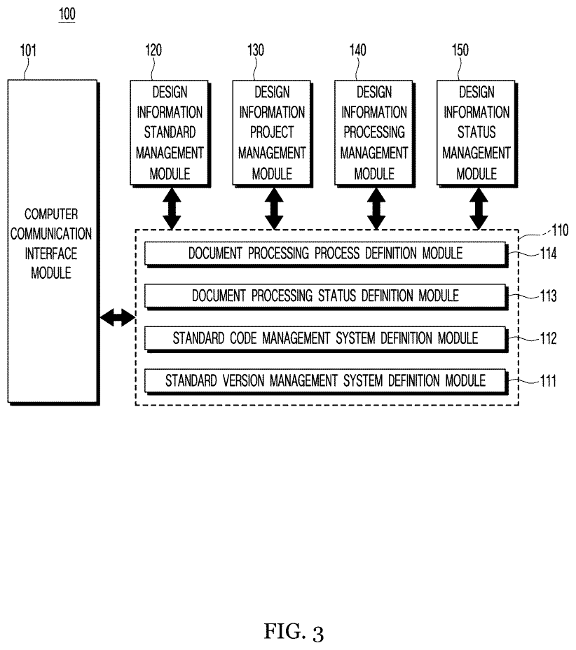

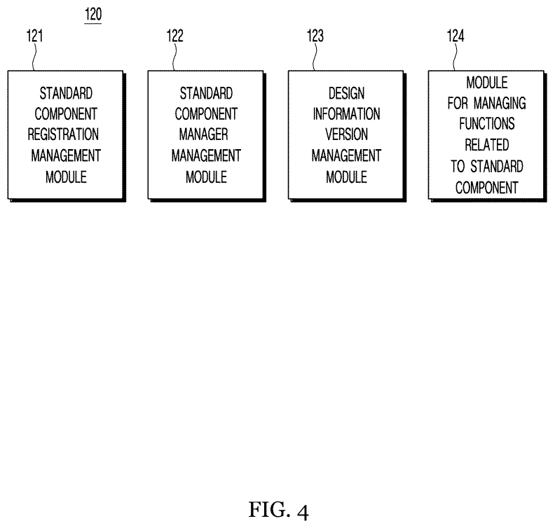

FIG. 2 generally shows the design process to which the system for managing design information according to an embodiment of the present disclosure is applied, according to an embodiment of the present disclosure. FIG. 3 is a block diagram for showing the components of the system for managing design information, according to an embodiment of the present disclosure. FIGS. 4-7 show the components of each component in FIG. 3, according to embodiments of the present disclosure.

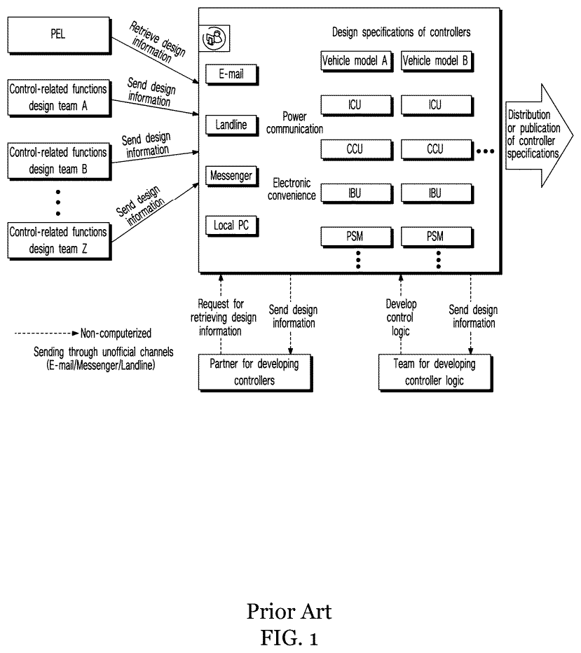

Compared to the conventional design process in FIG. 1 in which inquiries and responses are provided through non-computerized channels, in the design process in FIG. 2 to which the system for managing design information according to the present disclosure is applied, inquiries and responses may be provided through a computerized official channel, and information on the design of controllers with different characteristics and forms may be managed on a single standardized platform with a unified standard system, making it possible to add or remove controllers at a later time.

Therefore, in an embodiment, all electronic components, e.g., controllers, applied to the system for managing design information according to embodiments of the present disclosure must comply with standardization such as “document processing process,” “document processing status,” “standard code management system,” and “standard version management system” of a standardization module 110 shown in FIG. 3, and, if so, the design information may be managed systematically, as the functions of “design information standard management,” “design information project management,” “design information processing management,” and “design information status management” are performed.

As shown in FIG. 3, a system 100 for managing design information according to an embodiment of the present disclosure may include a computer communication interface module 101 for transmitting and receiving inquiries and responses thereto. The system 100 may also include a standardization module 110 for defining a standard version management system and a standard code management system for at least one electric component for vehicles as a document classification format and defining a document processing status and a document processing process to respond to requests received through the computer communication interface module based on the document classification format that has been defined. The system 100 may further include a design information standard management module 120 for registering the component based on the standardization module 110, designating a person in charge of the registered component, and managing the version of the registered component and the functions related thereto. The system 100 may additionally include a design information project management module 130 for registering the component applied to at least one vehicle model, managing the functions of the component and the functions related thereto, and requesting the person in charge to input information on the functions related thereto. The system 100 may also include a design information processing management module 140 for receiving information related to the component applied to the vehicle model and then creating and reviewing the information related thereto. The system 100 may additionally include a design information status management module 150 for retrieving the information related to the component applied to the vehicle model, receiving and managing the design information of the information related thereto, and then providing a notification of a change in the information.

The standardization module 110 may include a standard version management system definition module 111 for coding each version of the component into a first database when there are multiple versions of the component and then updating information on the version of the component based on the first database. The standardization module 110 may also include a standard code management system definition module 112 for indexing the component, coding the component into a second database based on the index, and then updating information on the code of the component based on the second database. The standardization module 110 may further include a document processing status definition module 113 for linking the first database and the second database and defining the status of documents based on a document classification format that has been defined. The standardization module 110 may additionally include a document processing process definition module 114 for defining a document processing process to respond to inquiries regarding design information from an external source based on the status of a document defined through the document processing status definition module 113.

As shown in FIG. 4, the design information standard management module 120 may include a standard component registration management module 121 for updating information on the component. The design information standard management module 120 may also include a standard component manager management module 122 for designating a person in charge of a registered standard component and updating information on the designated person. The design information standard management module 120 may additionally include a standard component version management module 123 for updating the version of the standard component. The design information standard management module 120 may also include a module for managing functions related to standard component 124 for updating information on the functions related to the standard component.

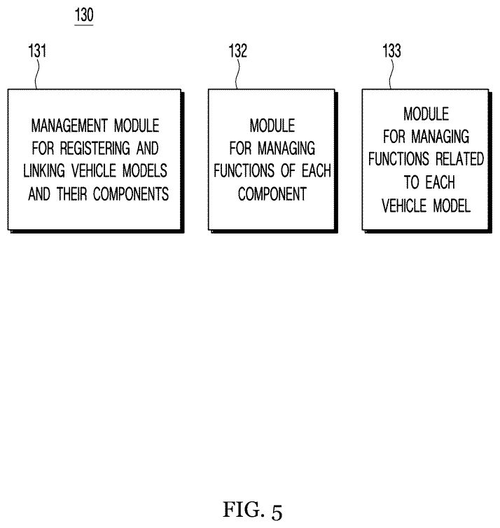

As shown in FIG. 5, the design information project management module 130 may include a management module 131 for registering and linking vehicle models and their components. For example, the management module 131 may register the vehicle model and at least one component applied to the registered vehicle model and link them. The design information project management module 130 may also include a module for managing functions of each component 132. For example, the module for managing functions of each component 132 may update and manage information on the functions of the component linked during the registering and linking of vehicle models and their components and the functions related to the component. The design information project management module 130 may additionally include a module for managing functions related to each vehicle model 133. The module for managing functions related to each vehicle model 133 may manage information on inquiries regarding the functions related to the component, that are updated and managed by the module for managing functions of each component 132, responses thereto, or a person in charge.

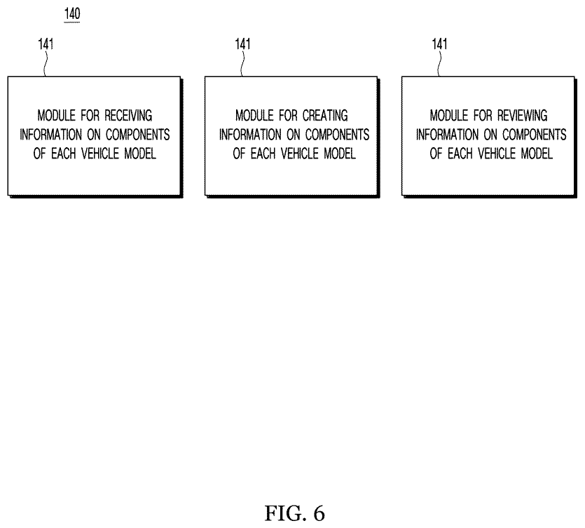

As shown in FIG. 6, the design information processing management module 140 may include a module for receiving information on components of each vehicle model 141. The design information processing management module 140 may inform the manager of the component of a received inquiry regarding information on the functions related to the component applied to the vehicle model. The design information processing management module 140 may also check whether the inquiry has been well received by the manager when it is determined that such an inquiry has been received. The design information processing management module 140 may also include a module for creating information on components of each vehicle model 142. The module for creating information on components of each vehicle model 142 may make responses to inquiries received through the module for receiving information on components of each vehicle model 141 and manage information on the responses. The design information processing management module 140 may additionally include a module for reviewing information on components of each vehicle model 143. The module for reviewing information on components of each vehicle model 143 may manage information on the inquires and the responses thereto when the requester has reviewed the response to the inquiry made through the module for creating information on components of each vehicle model 142 and expressed an opinion on the response: “review completed,” “another inquiry,” or “request for supplementation of answer.”

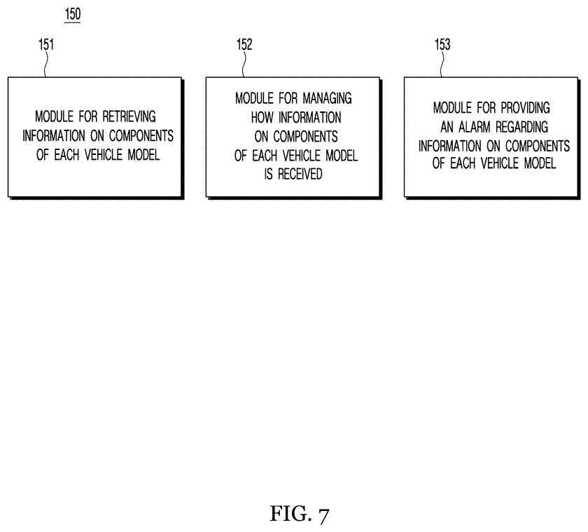

As shown in FIG. 7, the design information status management module 150 may include a module for retrieving information on components of each vehicle model 151. The module for retrieving information on components of each vehicle model 151 may retrieve design information based on the information on components of each vehicle model and make a request for design information varying as details progress. The design information status management module 150 may also include a module 152 for managing how information on components of each vehicle model is received. The module 152 may manage how the related functions have been received by each team for matters requested through the module for retrieving information on components of each vehicle model 151. The design information status management module 150 may additionally include a module 153 for providing an alarm regarding information on components of each vehicle model. The module 153 may provide a person in charge with an alarm regarding a request for additional information on the related functions when there is such a request among the requests managed by the module 152 for managing how information related to components of each vehicle model is received.

It should be noted that the modules may each include a memory in which a program for performing a corresponding module's function is stored and a processor for executing the program. It should also be noted that the memories of the modules may be integrated into one or more memories and the processors thereof may be integrated into one or more processors.

Hereinafter, how the system 100 for managing design information, as described above, is operated, according to an embodiment of the present disclosure, is described in more detail.

The system 100 for managing design information according to an embodiment of the present disclosure may first activate the standardization module 110 to index the electronic components of a vehicle, load information, and define a workflow based on inquiries and responses for design.

Here, the standardization module 110 may define a standard version management system for at least one electric component for vehicles and a standard code management system for the component as a document classification format. The standardization module 110 may also define a document processing status and a document processing process to respond to requests from an external source based on the document classification format that has been defined.

The standard version management system definition module 111 of the standardization module 110 may code each version of at least one electronic component in a vehicle into the first database when there are multiple versions of the component. The standard version management system definition module 111 may then update information on the version of the component based on the first database.

Here, the first database may be classified into a multi-layer structure: LV1. Major Classification (2-digit code)→LV2. Component (controller) (4-digit code)→LV3. Function (6-digit code)→LV4. Related Function (8-digit code), and each code may have an index function.

In addition, the standard code management system definition module 112 of the standardization module 110 may index the component, code the component into the second database based on the index, and then update information on the code of the component based on the second database.

Here, the second database may be classified into a multi-layer structure as is the first database, and the characteristics of each category may be as follows:

LV1. Major Classification, starting from “01” (2-digit code), where classification is made by center and TU, addition or deletion is not possible by users, and a request must be made to a computer manager when modification is necessary.

LV2. Component (controller), starting from “0001” (4-digit code) within the major classification, where classification is made by individual components (controller), and addition or deletion is possible by users, including a manager.

LV3. Function, starting from “000001” (6-digit code) within the classification by components, where classification is made by functions of individual components, and addition or deletion is possible by users, including a manager.

LV4. Related Function, starting from “00000001” (8-digit code) within the classification by functions of individual components, where classification is made by functions related to individual components, and addition or deletion is possible by users, including a manager.

In addition, the document processing process definition module 114 may link the first database defined through the standard version management system definition module 111 and the second database defined through the standard code management system definition module 112. the document processing process definition module 114 may define a document processing process in which responses to inquiries regarding design information from an external source are made based on the document status defined through the document processing status definition module 113 for defining a document status based on the document classification format that has been defined.

For example, a designer may make a response to an inquiry received through the computer communication interface module 101 according to the procedure through the document processing process definition module 114, and the history of inquiries and responses and information thereon may be accumulated and used as a guideline in the design of new vehicle models.

The design information standard management module 120 for registering the component based on the standardization module 110, designating a person in charge of the registered component, and managing the version of the registered component and the functions related thereto may include the standard component registration management module 121 for updating information on the component based on the standardization module 110.

The standard component registration management module 121 may perform the process of adding/modifying/removing the standard component. The standard component registration management module 121 may select the major classification by selecting a 2-digit standard code and then register the name, the 4-digit standard code, and the version of the component.

The standard component manager management module 122 may designate a person in charge of a registered standard component and update information on the designated person in charge. In an embodiment, when an inquiry regarding the standard component is received, the standard component manager management module 122 may designate an in-house person in charge and an external person in charge to answer the inquiry, and may perform the process of adding/modifying/removing the information on the designation of the persons in charge.

The standard component version management module 123 may update the version of the standard component and may register the initial version of the standard component as version X.xx, may add +1 to information on an added version starting from the second decimal place. The standard component version management module 123 may set the current version of the standard component as the version thereof. The standard component version management module 123 may also check whether the current version overlaps with the existing versions.

The module for managing functions related to standard component 124 may update information on the functions related to the standard component. The module for managing functions related to standard component 124 may register the name of the function of the standard component and a 6-digit standard code, may register the name of functions that can be related thereto and an 8-digit standard code, and may then register information on inquiries/responses/options regarding the related functions in a viewable form.

After the design information standard management module 120 has operated as described above, the design information project management module 130 may operate and serve to register the component applied to at least one vehicle model, manage the functions of the component and the functions related thereto, and request the person in charge to input the information on the functions related thereto.

In other words, based on the standardization module 110, the design information project management module 130 may serve to check the version of a component available for newly registered vehicle models and designate a person in charge of the component through the management module 131 for registering and linking vehicle models and their components, which may register the vehicle model and at least one component applied to the registered vehicle model and link them.

The module for managing functions of each component 132 may update and manage information on the functions of the component linked during the registering and linking of vehicle models and their components and the functions related to the component. The module for managing functions of each component 132 may modify the functions of the component and the functions related thereto to fit the vehicle model and manage the modified information and the added information as additional items.

The module for managing functions related to each vehicle model 133 may manage information on inquiries regarding the functions related to the component, that are updated and managed by the module for managing functions of each component 132, responses thereto, or a person in charge, may receive inquiries regarding the functions related to the component, inform the person in charge thereof of the inquiries, and manage the response deadline, the information on the response recipient, and the content of the response.

The module for receiving information on components of each vehicle model 141 may inform the manager of the component of a received inquiry regarding information on the functions related to the component applied to the vehicle model. The module for receiving information on components of each vehicle model 141 may also check whether the inquiry has been well received by the manager when it is determined that such an inquiry has been received. The module for receiving information on components of each vehicle model 141 may additionally check whether the content of an inquiry regarding information on the functions related to the component applied to the vehicle model requires a person in charge of the component to answer, and, if so, designate the person in charge as a main answerer and internal and external persons in charge as auxiliary answerers when it is determined that such an inquiry has been received.

The module for creating information on components of each vehicle model 142 may make responses to inquiries received through the module for receiving information on components of each vehicle model 141. The module for creating information on components of each vehicle model 142 may also manage information on the responses. The module for creating information on components of each vehicle model 142 may send a response to an inquiry regarding the related functions through a computer process after the main answerer has made the response to the inquiry based on the content of the response made by the auxiliary answerer.

Other components may operate as described above in the descriptions thereof, so descriptions of their operations have not been repeated herein.

Design information with different characteristics for each controller has been managed in a non-standardized and non-computerized manner for each controller, vehicle model, and person in charge. As a result, design information may be missing, it is not possible to reuse design information, the complexity of design information increases, and design quality deteriorates, leading to massive loss of the entire vehicle, such as deterioration in quality, increase in development period, and increase in cost. Embodiments the present disclosure provide a method and system for managing information on the design of electric components for vehicles in order to efficiently manage information on the design of vehicle controllers, of which the number of types is rapidly increasing due to the electronics and advancement of vehicles, and secure versatility/extendibility/standardization of the design information while improving the competitiveness of vehicles by enhancing the quality of controller design.

Example embodiments of the present disclosure have been shown and described, but the present disclosure is not limited to the specific embodiments described above. Rather, various modifications can be made to the present disclosure within the gist of the present disclosure claimed in the appended claims by a person having ordinary skill in the art, and such modifications should not be understood separately from the technology of the present disclosure.

The foregoing descriptions of the specific embodiments of the present disclosure have been presented for the purposes of illustration and description. They are not intended to be exhaustive or to limit the present disclosure to the precise forms disclosed, and many modifications and variations are possible in light of the above-described teachings. The embodiments were chosen and described to explain certain principles of the present disclosure and their practical application, to enable those having ordinary skill in the art to make and utilize the described embodiments of the present disclosure, as well as various alternatives and modifications thereof. It is intended that the scope of the present disclosure be defined by the claims appended hereto and their equivalents.

What is claimed is:

1. A method of managing information related to electric components for vehicles, the method comprising:
a standardization step of defining a standard version management system and a standard code management system for at least one electric component in a document classification format and defining a document processing status and a document processing process to respond to requests from an external source based on the document classification format;
a design information standard management step of registering the at least one electric component as a standard component based on the standardization step and managing information on a version and a related function of the standard component;
a design information project management step of registering at least one standard component applied to at least one vehicle model and managing a function of the standard component and functions related thereto;
a design information processing management step of receiving information related the standard component applied to the vehicle model and reviewing reliability of the information related thereto; and
a design information status management step of receiving design information of the information related the standard component applied to the vehicle model and updating and notifying changed information.

2. The method of claim 1, wherein the standardization step includes:
a standard version management system definition step of coding respective versions related to the electric component into a first database and updating information on a version of the electric component based on the first database;
a standard code management system definition step of indexing the electric component, coding the electric component into a second database based on the index, and updating information on a code of the electric component based on the second database;
a document processing state definition step of linking the first database and the second database and defining a document state based on the document classification format; and
a document processing process definition step of defining a document processing process to respond to an inquiry regarding design information from an external source based on the document state defined in the document processing state definition step.

3. The method of claim 1, wherein, based on the standardization step, the design information standard management step includes:
a standard component registration management step of updating information on the electric component;
a standard component manager management step of updating information on a person in charge of the standard component;
a standard component version management step of updating a version of the standard component; and
a standard component related functions management step of updating information on functions related to the standard component.

4. The method of claim 3, wherein the standard component registration management step includes selecting a major classification for the standard component by selecting a 2-digit standard code and registering a name, a 4-digit standard code, and the version of the standard component.

5. The method of claim 3, wherein, in the standard component manager management step, when an inquiry regarding the standard component is received, a designated person in charge is informed of receipt of the inquiry through a computerized system, and information on the person in charge is updated.

6. The method of claim 3, wherein, in the standard component version management step, i) an initial version of the standard component is registered as version X.xx (x is an integer determined from 1 to 9), wherein additional versions are registered by increasing the second decimal place of the version X.xx by 1, ii) a latest version of the standard component is set as a current version, and iii) it is checked whether the current version overlaps with existing versions.

7. The method of claim 3, wherein, in the standard component related functions management step, i) a name of a function of the standard component and a 6-digit standard code are registered, ii) names of functions that can be related to the standard component and an 8-digit standard code are registered, and iii) information on inquiries/responses/options regarding the functions related to the standard component is registered in a viewable form.

8. The method of claim 1, wherein, based on the standardization step, the design information project management step includes:
a step of registering and linking vehicle models and their components, in which the vehicle models and at least one standard component applied to each of the vehicle models are registered and linked to each other;
a step of managing functions of each component, in which information on the functions of the standard component linked in the step of registering and linking vehicle models and their components and the functions related to the component is updated and managed; and
a step of managing functions related to each vehicle model, in which information on one or both of inquiries or responses regarding the functions related to the component, that are updated and managed in the step of managing functions of each component is managed.

9. The method of claim 8, wherein, in the step of managing functions of each component, the functions of the component and the functions related thereto are modified to fit the vehicle model, and modified information and added information are managed as additional items.

10. The method of claim 1, wherein, based on the standardization step, the design information status management step includes:
a step of retrieving information on components of each vehicle model, in which design information is retrieved based on the information on components of each vehicle model and a request for design information varying as details progress is made;
a step of managing how information on components of each vehicle model is received, in which how the related functions have been received by each team is managed for matters requested in the step of retrieving information on components of each vehicle model; and
a step of providing an alarm regarding information on components of each vehicle model, in which an alarm regarding a request for additional information on the related functions is provided to a person in charge when there is such a request among the requests managed in the step of managing how information on components of each vehicle model is received.

11. A system for managing information related to electric components for vehicles, the system comprising:
a computer communication interface module configured to update and retrieve information and transmit and receive inquiries and responses;
a standardization module configured to define a standard version management system and a standard code management system for at least one electric component for vehicles in a document classification format and define a document processing status and a document processing process to respond to requests received through the computer communication interface module based on the document classification format;
a design information standard management module configured to register the at least one electric component as a standard component through the computer communication interface module based on the standardization module and manage information on a version and a related function of the standard component;
a design information project management module configured to register at least one standard component applied to at least one vehicle model through the computer communication interface module based on the standardization module and manage a function of the standard component and functions related thereto;
a design information processing management module configured to receive information related to the standard component applied to the vehicle model through the computer communication interface module based on the standardization module and review reliability of the information related thereto; and
a design information status management module configured to receive the design information of the information related to the standard component applied to the vehicle model through the computer communication interface module based on the standardization module, and update and provide a notification of changed information.

12. The system of claim 11, wherein the standardization module includes:
a standard version management system definition module configured to code respective versions related to the electric component into a first database and update information on a version of the electric component based on the first database;
a standard code management system definition module configured to index the electric component, code the electric component into a second database based on the index, and update information on a code of the electric component based on the second database;
a document processing state definition module configured to link the first database and the second database and define a document state based on the document classification format; and
a document processing process definition module configured to define a document processing process to respond to an inquiry regarding design information from an external source based on the document state defined through the document processing state definition module.

13. The system of claim 11, wherein the design information standard management module includes:
a standard component registration management module configured to update information on the electric component;
a standard component manager management module configured to update information on a person in charge of the standard component;
a standard component version management module configured to update a version of the standard component; and
a standard component related functions management module configured to update information on functions related to the standard component.

14. The system of claim 13, wherein the standard component registration management module is configured to select a major classification for the standard component by selecting a 2-digit standard code and register a name, a 4-digit standard code, and the version of the standard component.

15. The system of claim 13, wherein the standard component manager management module is configured to inform a designated person in charge of receipt of an inquiry regarding the standard component through a computerized system when the inquiry has been received so that information on the person in charge can be updated.

16. The system of claim 13, wherein the standard component version management module is configured to i) register an initial version of the standard component as version X.xx (x is an integer determined from 1 to 9), wherein additional versions are registered by increasing the second decimal place of the version X.xx by 1, ii) set a latest version of the standard component as a current version, and iii) check whether the current version overlaps with existing versions.

17. The system of claim 13, wherein the standard component related functions management module is configured to:
register a name of a function of the standard component and a 6-digit standard code;
register names of functions that can be related to the standard component and an 8-digit standard code; and
register information on inquiries/responses/options regarding the functions related to the standard component in a viewable form.

18. The system of claim 11, wherein the design information project management module includes:
a management module configured to register and link vehicle models and components, including registering and linking each of the vehicle models and at least one standard component applied to each of the vehicle models;
a module for managing functions of each component, which is for updating and managing information on the functions of the standard component linked through the management module for registering and linking vehicle models and their components and the functions related to the component; and
a module for managing functions related to each vehicle model, the module configured to manage information on one or both of inquiries or responses regarding the functions related to the component, wherein the functions are updated and managed through the module for managing functions of each component.

19. The system of claim 18, wherein the module for managing functions of each component is configured to:
modify the functions of the component and the functions related thereto to fit the vehicle model; and
manage modified information and added information as additional items.

20. The system of claim 11, wherein, the design information status management module includes:
a module for retrieving information on components of each vehicle model, the module configured to retrieve design information based on the information on components of each vehicle model and make a request for design information varying as details progress;
a module for managing how information on components of each vehicle model is received, the module configured to manage how the related functions have been received by each team for matters requested through the module for retrieving information on components of each vehicle model; and
a module for providing an alarm regarding information on components of each vehicle model, the module configured to provide an alarm regarding a request for additional information on the related functions to a person in charge when there is such a request among the requests managed through the module for managing how information on components of each vehicle model is received.
